(19) United States
(12) Patent Application Publication
(10) Pub. No.: US 2014/0254535 A1
(43) Pub. Date: Sep. 11, 2014

(54) TRANSMITTING APPARATUS AND TRANSMITTING METHOD

(71) Applicant: Panasonic Corporation, Osaka (JP)

(72) Inventor: Hiroaki Sudo, Kanagawa (JP)

(73) Assignee: Panasonic Corporation, Osaka (JP)

(21) Appl. No.: 14/352,019

(22) PCT Filed: Oct. 10, 2012
(86) PCT No.: PCT/JP2012/006472

§ 371 Date: Apr. 15, 2014

(30) Foreign Application Priority Data
Nov. 10, 2011 (JP) 2011-246482

(51) Int. Cl. H04W 72/04; H04L 5/00

(52) U.S. Cl. CPC H04W 72/0453; H04L 5/0092
USPC 370/329

(57) ABSTRACT

In a transmitting apparatus, a transmission rate request signal generating unit (102) generates, for each of a plurality of frequencies, a transmission rate request signal that is used for requesting a transmission rate for each of the plurality of frequencies and that is constituted by a plurality of bits. A higher-order-bit transmission control unit (104) establishes frequencies for transmitting higher-order bits of a CQI such that a first frequency interval in which the higher-order bits are transmitted is longer than a second frequency interval in which the lower-order bits of the CQI are transmitted. A lower-order-bit transmission control unit (105) establishes frequencies for transmitting the lower-order bits of the CQI. The transmitting apparatus (100) uses the frequencies, which have been established by the higher-order-bit transmission control unit (104) and lower-order-bit transmission control unit (105), to transmit the higher-order bits and lower-order bits of the CQI.

### TECHNICAL FIELD

The present invention relates to a transmission apparatus and a transmitting method that request a transmission rate using a transmission rate request signal.

### BACKGROUND ART

In the 3GPP (3rd Generation Partnership Project) standard, today, it has been discussed that a transmission rate request signal (CQI (Channel Quality Indicator) in the 3GPP standard)) is transmitted from a transmission apparatus such as a communication terminal apparatus to a reception apparatus such as a base station apparatus as a control signal for requesting the setting of a transmission rate. The reception apparatus selects a transmission rate in accordance with the received CQI. The CQI includes multiple bits.

Some conventional methods for transmitting a transmission rate request signal involve a fixed transmission time for transmitting a transmission rate request signal, and cause a transmission apparatus to transmit all the bits of a transmission rate request signal when the transmission time comes (for example, Non-Patent Literature (hereinafter, abbreviated as NPL) 1).

### CITATION LIST

### Non-Patent Literature

### NPL 1

3GPP TS25.212 V8.6.0 (2009-09)

### SUMMARY OF INVENTION

### Technical Problem

However, in Non-Patent Literature 1, since all the bits of a transmission rate request signal are always transmitted, the amount of information of the transmission rate request signal increases. Consequently, such a transmission apparatus involves a problem of an increase in the power consumption for transmission of a transmission rate request signal. Furthermore, an increase in the amount of information of a transmission rate request signal causes a problem of an increase in the amount of interference with other terminals by the transmission rate request signal.

In this respect, it is possible to extend the transmission interval of a transmission rate request signal in order to reduce the amount of information of the transmission rate request signal. However, the channel condition changes every moment. Therefore, a longer transmission interval of a transmission rate request signal may cause an error between the channel condition at the time of receiving a transmission rate request signal in a reception apparatus and the actual channel condition at that time. Such an error may deteriorate the accuracy of a transmission rate request signal. As a result, the reception apparatus cannot select a suitable transmission rate and therefore causes a problem of a decrease in the throughput.

As described above, there is a trade-off relationship between reduction in the amount of information of a transmission rate request signal and the throughput.

It is an object of the present invention to provide a transmission apparatus and a transmitting method that can reduce the information amount of a transmission rate request signal without decreasing the throughput and achieve low power consumption by making the frequency interval for transmitting high-order bits of the transmission rate request signal longer than the frequency interval for transmitting low-order bits of the transmission rate request signal.

### Solution to Problem

A transmission apparatus according to an aspect of the present invention includes: a generation section that generates a transmission rate request signal for each of frequencies, the transmission rate request signal including a plurality of bits for requesting a transmission rate for each of the frequencies; a control section that sets a frequency for transmitting a high-order bit and a frequency for transmitting a low-order bit so that a first frequency interval for transmitting the high-order bit in the plurality of bits is longer than a second frequency interval for transmitting the low-order bit other than the high-order bit in the plurality of bits; and a transmission section that transmits the high-order bit and the low-order bit using the frequencies that are set by the control section.

A transmitting method according to an aspect of the present invention includes: generating a transmission rate request signal for each of frequencies, the transmission rate request signal including a plurality of bits for requesting a transmission rate for each of the frequencies; setting a frequency for transmitting a high-order bit and a frequency for transmitting a low-order bit so that a first frequency interval for transmitting the high-order bit in the plurality of bits is longer than a second frequency interval for transmitting the low-order bit other than the high-order bit in the plurality of bits; and transmitting the high-order bit and the low-order bit using the set frequencies.

### Advantageous Effects of Invention

According to the present invention, it is possible to reduce the information amount of the transmission rate request signal without decreasing the throughput and to achieve low power consumption by making the frequency interval for transmitting high-order bits of the transmission rate request signal longer than the frequency interval for transmitting low-order bits of the transmission rate request signal.

### BRIEF DESCRIPTION OF DRAWINGS

FIG. 1 is a block diagram illustrating a configuration of a transmission apparatus according to Embodiment 1 of the present invention;

FIG. 2 is a block diagram illustrating a configuration of a reception apparatus according to Embodiment 1 of the present invention;

FIG. 3 illustrates subcarrier groups according to Embodiment 1 of the present invention;

FIG. 4 illustrates a CQI transmitting method according to Embodiment 1 of the present invention;

FIG. 5 is a block diagram illustrating a configuration of a transmission apparatus according to Embodiment 2 of the present invention;

FIG. 6 is a block diagram illustrating a configuration of a transmission apparatus according to Embodiment 3 of the present invention;

FIG. 7 illustrates CQI transmitting method 1 according to Embodiment 3 of the present invention;

FIG. 8 illustrates CQI transmitting method 2 according to Embodiment 3 of the present invention;

FIG. 9 is a block diagram illustrating a configuration of a transmission apparatus according to Embodiment 4 of the present invention;

FIG. 10 illustrates a CQI transmitting method according to Embodiment 4 of the present invention;

FIG. 11 is a block diagram illustrating a configuration of a transmission apparatus according to Embodiment 5 of the present invention;

FIG. 12 illustrates a CQI transmitting method according to Embodiment 5 of the present invention;

FIG. 13 is a block diagram illustrating a configuration of a transmission apparatus according to Embodiment 6 of the present invention;

FIG. 14 illustrates a CQI transmitting method for a CQI transmitted from one of two antennas according to Embodiment 6 of the present invention;

FIG. 15 illustrates a CQI transmitting method for a CQI transmitted from the other one of the two antennas according to Embodiment 6 of the present invention;

FIG. 16 is a block diagram illustrating a configuration of a transmission apparatus according to Embodiment 7 of the present invention; and

FIG. 17 illustrates a CQI transmitting method according to Embodiment 7 of the present invention.

### DESCRIPTION OF EMBODIMENTS

Hereinafter, the embodiments according to the present invention will be described in detail with reference to the accompanying drawings.

### Embodiment 1

### <Configuration of Transmission Apparatus>

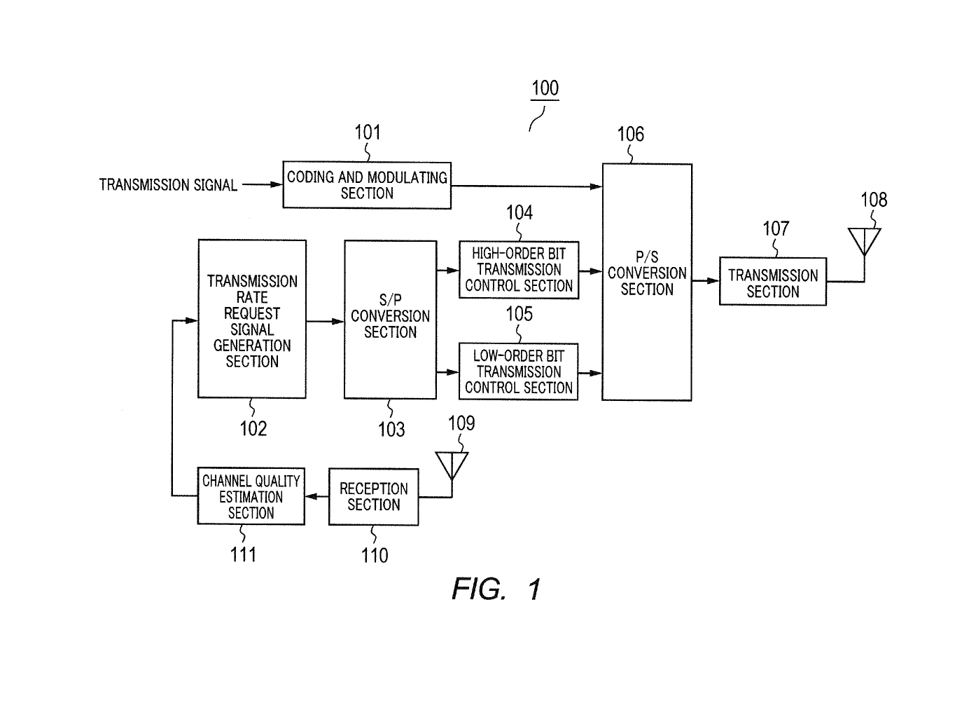

FIG. 1 is a block diagram illustrating a configuration of transmission apparatus 100 according to Embodiment 1 of the present invention. Transmission apparatus 100 is applicable to a communication terminal apparatus, such as a mobile telephone.

Coding and modulating section 101 performs an encode process and a modulation process on an inputted transmission signal. Coding and modulating section 101 outputs the transmission signal after the modulation process to P/S conversion section 106.

Transmission rate request signal generation section 102 generates a CQI as a control signal for requesting a transmission rate, in accordance with an estimation result of a channel quality representing the channel condition of transmission apparatus 100, the estimation result being inputted from channel quality estimation section 111 described below. Transmission rate request signal generation section 102 outputs the generated CQI to S/P conversion section 103. Note that, the CQI is a transmission rate request signal including multiple bits for requesting a transmission rate for each subcarrier group (each frequency), and is generated for each subcarrier group.

S/P conversion section 103 converts (serial/parallel (S/P) conversion), into a parallel data form, the CQI inputted in a serial data form from transmission rate request signal generation section 102. S/P conversion section 103 separates, into high-order bits and low-order bits, the CQI converted into a parallel data form. S/P conversion section 103 outputs the high-order bits of the CQI to high-order bit transmission control section 104, and outputs the low-order bits of the CQI to low-order bit transmission control section 105.

High-order bit transmission control section 104 determines a subcarrier group for transmitting the high-order bits of the CQI inputted from S/P conversion section 103. In this case, high-order bit transmission control section 104 sets the subcarrier group for transmitting the high-order bits so that the transmission frequency interval of the high-order bits of the CQI is longer than the transmission frequency interval of the low-order bits of the CQI that is set in low-order bit transmission control section 105 described below. High-order bit transmission control section 104 sets the subcarrier group and then outputs the high-order bits of the CQI to P/S conversion section 106. High-order bit transmission control section 104 causes the transmission frequency interval of the high-order bits of the CQI to be fixed or variable. A method for setting the transmission frequency intervals of the high-order bit and the low-order bit will be described below.

Low-order bit transmission control section 105 sets a subcarrier group for transmitting the low-order bits of the CQI inputted from S/P conversion section 103. In this case, low-order bit transmission control section 105 sets the subcarrier group for transmitting the low-order bits so that the transmission frequency interval of the low-order bits of the CQI is shorter than the transmission frequency interval of the high-order bits of the CQI that is set in high-order bit transmission control section 104. Low-order bit transmission control section 105 sets the subcarrier group and then outputs the low-order bits of the CQI to P/S conversion section 106.

P/S conversion section 106 converts, into series, the high-order bit of the CQI inputted in parallel from high-order bit transmission control section 104, or the low-order bit of the CQI inputted in parallel from low-order bit transmission control section 105 (parallel/serial (P/S) conversion). P/S conversion section 106 generates one sequence signal including the transmission signal inputted from coding and modulating section 101, and the high-order bit of the CQI inputted from high-order bit transmission control section 104 or the low-order bit of the CQI inputted from low-order bit transmission control section 105. P/S conversion section 106 outputs the generated signal to transmission section 107.

Transmission section 107 performs a transmission process on the signal inputted from P/S conversion section 106, and outputs the signal after the transmission process, to antenna 108.

Antenna 108 transmits the signal inputted from transmission section 107. Thus, the high-order bits and low-order bits the CQI are transmitted based on the respective transmission frequency intervals that are set in high-order bit transmission control section 104 and low-order bit transmission control section 105.

Antenna 109 receives a signal and outputs the received signal to reception section 110.

Reception section 110 performs a reception process on the signal inputted from antenna 109, and outputs the signal after the reception process to channel quality estimation section 111.

Channel quality estimation section 111 estimates a channel quality using the signal inputted from reception section 110, and outputs the estimation result to transmission rate request signal generation section 102.

### <Configuration of Reception Apparatus>

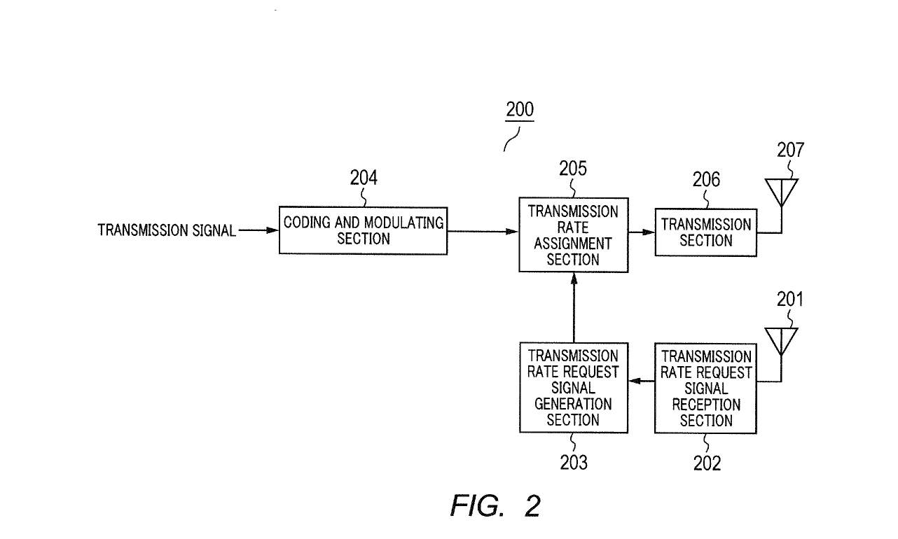

FIG. 2 is a block diagram illustrating a configuration of reception apparatus 200 according to Embodiment 1 of the present invention. Reception apparatus 200 is applicable to, for example, a base station apparatus.

Antenna 201 receives a signal and outputs the received signal to transmission rate request signal reception section 202.

Transmission rate request signal reception section 202 performs a reception process on the signal inputted from antenna 201, and acquires the high-order bit or low-order bit of the CQI. Transmission rate request signal reception section 202 outputs the acquired high-order bit or low-order bit of the CQI to transmission rate request signal generation section 203.

Transmission rate request signal generation section 203 generates a CQI based on the high-order bit or low-order bit of the CQI inputted from transmission rate request signal reception section 202. More specifically, transmission rate request signal generation section 203 generates, for the subcarrier group for having acquired only the low-order bit of the CQI, a CQI using the low-order bit of the acquired CQI and the high-order bit of a CQI for another subcarrier group. Transmission rate request signal generation section 203 outputs the generated CQI to transmission rate assignment section 205. In addition, when both the high-order bits and low-order bits of the CQI are inputted from transmission rate request signal reception section 202, transmission rate request signal generation section 203 outputs the inputted bits to transmission rate assignment section 205 as a CQI without modification.

Coding and modulating section 204 performs an encode process and a modulation process on the inputted transmission signal. Coding and modulating section 204 outputs the transmission signal after the modulation process to transmission rate assignment section 205.

Transmission rate assignment section 205 assigns the transmission rate to the transmission signal inputted from coding and modulating section 204, based on the CQI inputted from transmission rate request signal generation section 203. Transmission rate assignment section 205 outputs the transmission signal assigned the transmission rate to transmission section 206.

Transmission section 206 performs a transmission process on the transmission signal inputted from transmission rate assignment section 205, and outputs the transmission signal after the transmission process to antenna 207.

Antenna 207 transmits the transmission signal inputted from transmission section 206. Thereby, transmission apparatus 100 transmits the transmission signal at the transmission rate requested by the CQI.

### <CQI Transmitting Method>

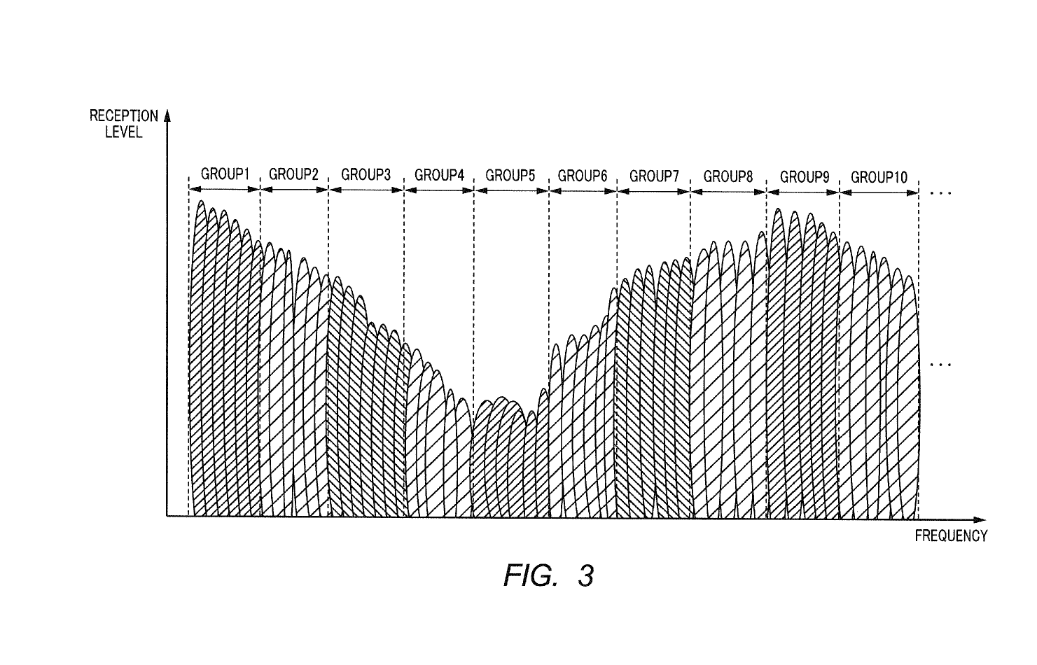

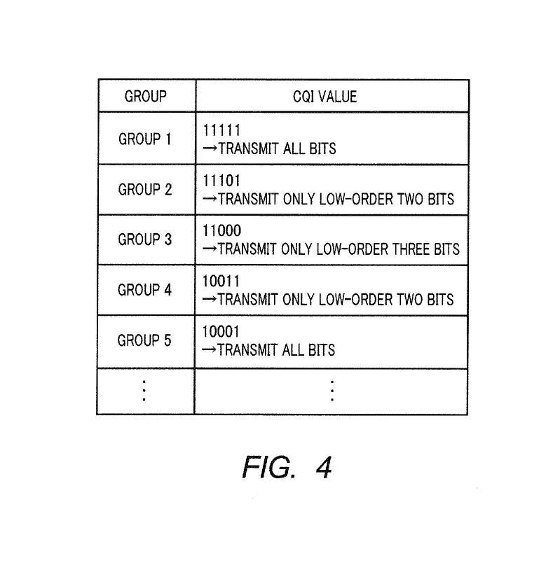

A CQI transmitting method will be explained in detail with reference to FIG. 3 and FIG. 4. FIG. 3 illustrates subcarrier groups according to Embodiment 1 of the present invention. FIG. 4 illustrates the CQI transmitting method according to Embodiment 1 of the present invention.

Hereinafter, an example case will be explained where the number of bits of the CQI is set to 5 bits. In this case, S/P conversion section 103 outputs three high-order bits in the 5-bit CQI to high-order bit transmission control section 104, and outputs low-order two bits to low-order bit transmission control section 105. Hereinafter, it is assumed that a CQI having a larger (or smaller) value requests a higher value transmission rate. For example, a bit string “00000” (or “11111”) included in a CQI corresponds to the lowest transmission rate, and a bit string “11111” (or “00000”) included in a CQI corresponds to the highest transmission rate. That is, “00000” to “11111” (or “11111” to “00000”) corresponds in ascending order from the lowest transmission rate.

Low-order bit transmission control section 105 sets, as n=1, the transmission subcarrier group interval n for low-order two bits of the CQI. That is, low-order bit transmission control section 105 sets groups 1, 2, 3, 4, . . . illustrated in FIG. 3, as a subcarrier group for transmitting low-order two bits of the CQI.

High-order bit transmission control section 104 sets, as n=4, a transmission subcarrier group interval n for high-order two bits of the CQI. That is, high-order bit transmission control section 104 sets groups 1, 5, 9, . . . illustrated in FIG. 3, as a subcarrier group for transmitting high-order two bits of the CQI.

Moreover, high-order bit transmission control section 104 sets, as n=2, a transmission subcarrier group interval n for the third bit from the high order. That is, high-order bit transmission control section 104 sets groups 1, 3, 5, 7, . . . illustrated in FIG. 3, as a subcarrier group for transmitting the third bit from the high order of the CQI.

As a result described above, all the bits of the high-order bits and low-order bits of the CQI are transmitted for groups 1, 5, 9, . . . illustrated in FIG. 3. Moreover, only low-order three bits of the CQI are transmitted for groups 3, 7, . . . illustrated in FIG. 3. Moreover, only low-order two bits of the CQI are transmitted for groups 2, 4, 6, 8, 10, . . . illustrated in FIG. 3.

More specifically with reference to FIG. 4, transmission apparatus 100 transmits all the bits “11111” of the CQI for group 1 illustrated in FIG. 3. Moreover, transmission apparatus 100 transmits all the bits “10001” of the CQI for group 5 illustrated in FIG. 3. On the other hand, transmission apparatus 100 transmits only low-order two bits for group 2 illustrated in FIG. 3. Transmission apparatus 100 transmits only low-order three bits “000” for group 3 illustrated in FIG. 3. Transmission apparatus 100 transmits only low-order two bits “11” for group 4 illustrated in FIG. 3.

### <CQI Generating Method in Reception Apparatus>

With reference to FIG. 4, reception apparatus 200 receives all the bits of CQI for group 1 and group 5 illustrated in FIG. 3. On the other hand, reception apparatus 200 receives only low-order two bits for group 2 illustrated in FIG. 3, but transmission rate request signal generation section 203 can generate all the bits “11101” of the CQI using the received low-order two bits “01” and high-order three bits “111” for group 1. Moreover, reception apparatus 200 receives only low-order three bits for group 3 illustrated in FIG. 3, but transmission rate request signal generation section 203 can generate all the bits “11000” of the CQI using the received low-order three bits “000” and high-order two bits “11” for group 1. Reception apparatus 200 receives only low-order two bits for group 4 illustrated in FIG. 3, but transmission rate request signal generation section 203 can generate all the bits “10011” of the CQI using the received low-order two bits “11” and high-order three bits “100” for group 5.

<Reason for Making Frequency Interval of Low-Order Bits Shorter than High-Order Bits>

The value of the CQI varies in accordance with the channel condition. A higher-order bit in multiple bits included in the CQI can represent a larger value. That is, a change in a high-order bit of the CQI makes a larger variation in a value represented by the CQI than a change in a low-order bit of the CQI.

Therefore, a CQI likely varies in the order from the low-order bit in general. That is, in multiple bits representing a CQI, the value of a lower-order bit varies more readily, and the value of a higher-order bit is more difficult to vary, in accordance with a variation in a channel condition (channel variation).

That is, even when extending a transmission frequency interval for transmitting the high-order bits of the CQI having a value that is difficult to vary in comparison with a transmission frequency interval for transmitting the low-order bits of the CQI having a value varying readily, transmission apparatus 100 can report the exact CQI to the reception apparatus. In other words, transmission apparatus 100 may decrease the number of times the high-order bits of the CQI are transmitted in comparison with the number of times the low-order bits of the CQI are transmitted.

Consequently, high-order bit transmission control section 104 sets a transmission frequency interval for the high-order bits of the CQI so as to be longer than a transmission frequency interval for the low-order bits of the CQI. In other words, low-order bit transmission control section 105 sets a transmission frequency interval for the low-order bits of the CQI so as to be shorter than a transmission frequency interval of the high-order bits of the CQI.

In the case of FIG. 3 and FIG. 4, the value of low-order two bits of the CQI likely varies between adjacent subcarrier group intervals. In contrast to this, the value of high-order three bits of the CQI unlikely varies between adjacent subcarrier group intervals. Therefore, even when a transmission interval for the high-order three bits of the CQI is longer than a transmission interval for the low-order two bits of the CQI (even if a transmission repetition for the high-order three bits of the CQI is lower than a transmission repetition for the low-order two bits of the CQI), the accuracy of the CQI used in each subcarrier group does not deteriorate in reception apparatus 200. As a result, there is no decrease in the throughput.

<Comparison with Related Art>

In a case where the number of subcarrier groups is 100 and the total number of bits of CQI is equal to 5, for example, when all the bits of the CQI are transmitted for all the subcarrier groups like related art, the number of transmission bits of the CQI needs to be 500 bits (5 bits×100) for each time (symbol). In contrast to this, according to the present embodiment, the number of transmission bits of the CQI needs to be only 300 bits (12 bits×25). Since power consumption is proportional to the transmission amount of a CQI, the present embodiment can reduce power consumption necessary for transmission of the CQI to three fifths of that in the related art. Moreover, according to the present embodiment, an interference amount given to other users can be reduced to three fifths of that in the related art.

### <Advantageous Effects of Present Embodiment>

The present embodiment makes a frequency interval for transmitting high-order bits longer than a frequency interval for transmitting low-order bits. This can reduce the information amount of the transmission rate request signal without decreasing the throughput and can achieve low power consumption.

Moreover, the present embodiment can reduce the information amount of a CQI without changing the format of the CQI, and only by controlling the frequency intervals for the high-order bits and low-order bits of the CQI.

### Embodiment 2

### <Configuration of Transmission Apparatus>

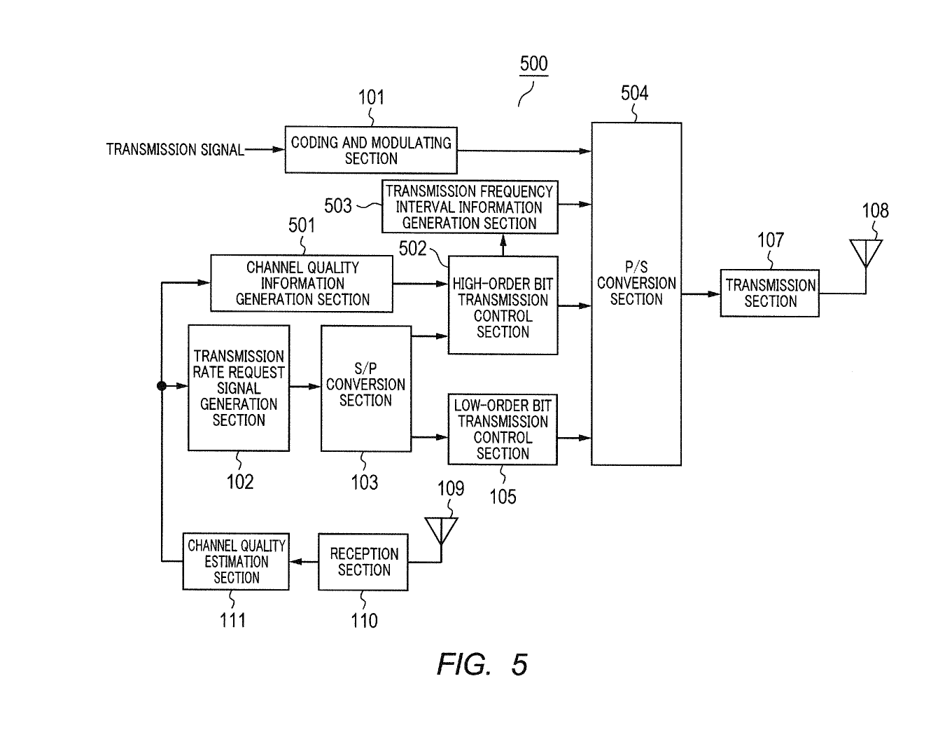

FIG. 5 is a block diagram illustrating a configuration of transmission apparatus 500 according to Embodiment 2 of the present invention. Transmission apparatus 500 is applicable to a communication terminal apparatus, such as a mobile telephone.

Transmission apparatus 500 illustrated in FIG. 5 is configured by adding channel quality information generation section 501 and transmission frequency interval information generation section 503 to transmission apparatus 100 according to Embodiment 1 illustrated in FIG. 1, having high-order bit transmission control section 502 instead of high-order bit transmission control section 104, and having P/S conversion section 504 instead of P/S conversion section 106. In FIG. 5, the same elements as those in FIG. 1 are designated with the same reference numerals, and explanations thereof will be omitted. Moreover, since a reception apparatus according to the present embodiment has the same configuration as that in FIG. 2, an explanation thereof will be omitted.

Coding and modulating section 101 performs an encode process and a modulation process on an inputted transmission signal. Coding and modulating section 101 outputs the transmission signal after the modulation process to P/S conversion section 504.

Channel quality information generation section 501 generates channel quality information representing a channel variation speed based on an estimation result of channel quality, which is inputted from channel quality estimation section 111, between transmission apparatuses 500 and reception apparatuses 200. Channel quality information generation section 501 outputs the generated channel quality information to high-order bit transmission control section 502. Here, a channel variation speed is calculated, for example, based on the amount of variation in the estimation result of channel quality.

High-order bit transmission control section 502 functions as a transmission control section for determining the transmission time for a CQI. High-order bit transmission control section 502 sets a transmission subcarrier group for the high-order bits of the CQI inputted from S/P conversion section 103. In this case, high-order bit transmission control section 502 sets a subcarrier group for transmitting the high-order bits in a way that makes a transmission frequency interval for the high-order bit of the CQI longer than a transmission frequency interval, which is set in low-order bit transmission control section 105, for the low-order bits of the CQI. Furthermore, high-order bit transmission control section 502 controls a transmission frequency interval of the high-order bits of the CQI so as to be variable in accordance with the delay spread (channel condition) represented by channel quality information inputted from channel quality information generation section 501. For example, high-order bit transmission control section 502 sets a subcarrier group so that a transmission frequency interval for the high-order bits of the CQI is shorter for larger delay spread (a more rapid variation in the reception level on the frequency domain).

High-order bit transmission control section 502 sets the subcarrier group and then outputs the high-order bits of the CQI to P/S conversion section 504. High-order bit transmission control section 502 outputs information representing a transmission frequency interval specified by the set subcarrier group to transmission frequency interval information generation section 503.

Low-order bit transmission control section 105 sets a transmission subcarrier group for the low-order bits of the CQI inputted from S/P conversion section 103. In this case, low-order bit transmission control section 105 sets the subcarrier group for transmitting the low-order bits in a way that makes the transmission frequency interval for the low-order bits of the CQI shorter than the transmission frequency interval for the high-order bits of the CQI that is set in high-order bit transmission control section 502. Low-order bit transmission control section 105 sets the subcarrier group and then outputs the low-order bits of the CQI to P/S conversion section 504.

Transmission frequency interval information generation section 503 generates transmission frequency interval information representing the transmission frequency interval for the high-order bits of the CQI at each transmission time for the CQI, based on information representing the transmission frequency interval inputted from high-order bit transmission control section 502. Transmission frequency interval information generation section 503 outputs the generated transmission frequency interval information to P/S conversion section 504.

In order to set a transmission frequency interval for the high-order bits of the CQI to be variable, reception apparatus 200 needs to specify a frequency interval for transmitting the high-order bits of the CQI. Therefore, transmission apparatus 500 transmits transmission frequency interval information as information for reception apparatus 200 specifying the time of transmitting the high-order bits of the CQI.

P/S conversion section 504 generates one sequence signal including the transmission signal inputted from coding and modulating section 101, the high-order bits of the CQI or the low-order bit of the CQI, and transmission frequency interval information inputted from transmission frequency interval information generation section 503. Since other parts of the configuration and operation of P/S conversion section 504 are the same as that of P/S conversion section 106 according to Embodiment 1, the explanation thereof will be omitted.

Transmission section 107 performs a transmission process on the signal inputted from P/S conversion section 504, and outputs the signal after the transmission process, to antenna 108.

### <CQI Transmitting Method>

Hereinafter, similarly to Embodiment 1, an example case will be explained where the number of bits of the CQI is set to five bits, three bits from the highest-order bit in the five bits are set as high-order bits, and two bits from the lowest-order bit are set as low-order bits.

For example, if a channel variation speed represented in the channel quality information inputted from channel quality information generation section 501 is equal to or greater than a predetermined threshold (if a channel variation speed is relatively high), high-order bit transmission control section 502 sets, as n=2, transmission subcarrier group interval n for the high-order three bits of the CQI. That is, high-order bit transmission control section 502 sets transmission subcarrier group interval n for the high-order three bits of the CQI so as to be twice the transmission subcarrier group interval n for the low-order two bits of the CQI.

On the other hand, if delay spread is smaller than a predetermined threshold (if delay spread is relatively large), high-order bit transmission control section 502 sets, as n=4, transmission subcarrier group interval n for the high-order two bits of the CQI. That is, high-order bit transmission control section 502 sets the transmission interval for the high-order two bits of the CQI so as to be quadruple the transmission interval for the low-order two bits of the CQI. Moreover, if delay spread is relatively small, high-order bit transmission control section 502 sets, for example, transmission subcarrier group interval n for the high-order two bits of the CQI, as n=8. That is, high-order bit transmission control section 502 sets a subcarrier group interval doubled as compared to the case of relatively large delay spread.

Here, a CQI is more likely to vary frequently for larger delay spread (a more rapid variation in the reception level between subcarrier groups). Therefore, in this case, transmission apparatus 500 needs to make the transmission interval for the high-order bits of the CQI shorter, and needs to increase the number of times the CQI is transmitted. On the other hand, a CQI is less likely to vary for a slower channel variation speed (a slower channel variation). In this case, transmission apparatus 500 further extends a transmission frequency interval for the high-order bits of the CQI, and reduces the number of times the CQI is transmitted. Also in this case, reception apparatus 200 can select a transmission rate using an exact CQI.

### <Advantageous Effects of Present Embodiment>

The present embodiment sets the transmission frequency interval for the high-order bits for the CQI to be variable in accordance with delay spread. Thereby, in addition to the advantageous effects of Embodiment 1, the high-order bits of the CQI can be transmitted as needed in accordance with delay spread, and the information amount of the CQI can be more reduced than that in Embodiment 1 without deterioration in the accuracy of the CQI.

### <Variation of Present Embodiment>

Although the present embodiment uses delay spread as a channel condition, the present invention is not limited to this configuration and may use a parameter which represents a channel condition other than delay spread as a channel condition.

### Embodiment 3

### <Configuration of Transmission Apparatus>

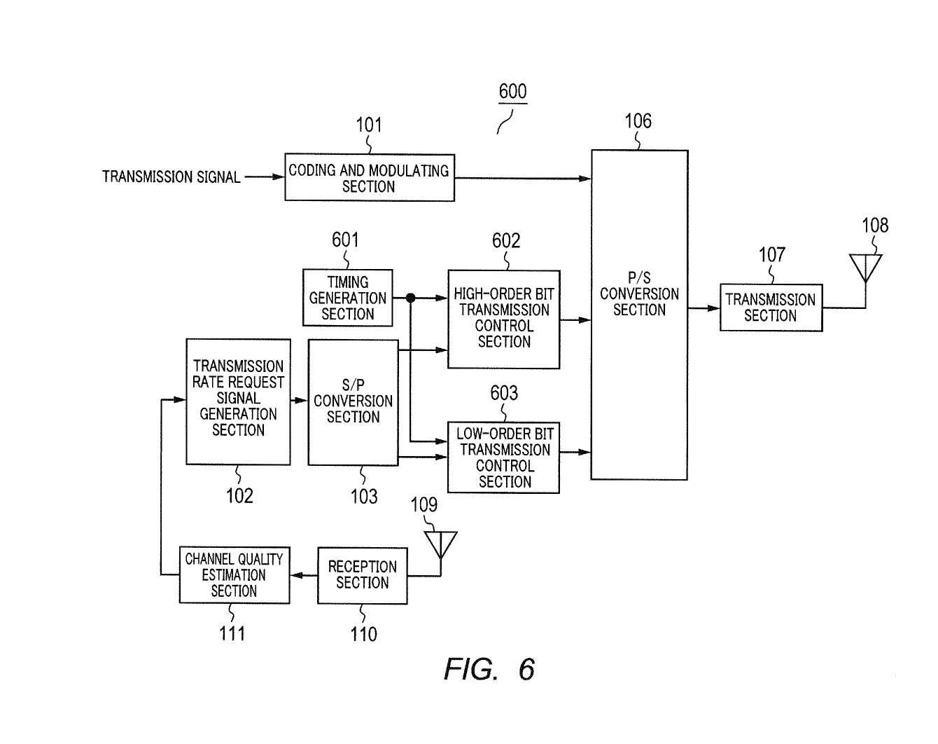

FIG. 6 is a block diagram illustrating a configuration of transmission apparatus 600 according to Embodiment 3 of the present invention. Transmission apparatus 600 is applicable to a communication terminal apparatus, such as a mobile telephone.

Transmission apparatus 600 illustrated in FIG. 6 includes a configuration in which timing generation section 601 is added and which includes high-order bit transmission control section 602 instead of high-order bit transmission control section 104, and low-order bit transmission control section 603 instead of low-order bit transmission control section 105. In FIG. 6, the same elements as those in FIG. 1 are designated with the same reference numerals, and the explanations thereof will be omitted. Moreover, since a reception apparatus according to the present embodiment has the same configuration as that in FIG. 2, the explanation thereof will be omitted.

Timing generation section 601 generates timing information representing the timing of transmitting the high-order bits and low-order bits of the CQI. Timing generation section 601 outputs the generated timing information to high-order bit transmission control section 602 and low-order bit transmission control section 603. Note that, the timing represented by the timing information is the timing of transmitting all the bits of the CQI. The timing of transmitting all the bits of the CQI is, for example, a communication start time (when communication starts) or a specific time after the start of communication. The specific time is, for example, a time when the reception level falls significantly due to multipath, i.e., when the value of CQI varies rapidly.

High-order bit transmission control section 602 determines a transmission time for the high-order bits of the CQI, based on the time represented by the timing information inputted from timing generation section 601. High-order bit transmission control section 602 outputs the high-order bits of the CQI to P/S conversion section 106 at the determined transmission time. Since other parts of the configuration and operation of high-order bit transmission control section 602 are the same as that of high-order bit transmission control section 104 according to Embodiment 1, the explanation thereof will be omitted.

Low-order bit transmission control section 603 determines a transmission time for the low-order bits of the CQI, based on the time represented by the timing information inputted from timing generation section 601. Low-order bit transmission control section 603 outputs the low-order bits of the CQI to P/S conversion section 106 at the determined transmission time. Since other parts of the configuration and operation of low-order bit transmission control section 603 are the same as that of low-order bit transmission control section 105 according to Embodiment 1, the explanation thereof will be omitted.

P/S conversion section 106 converts, into series, the high-order bits of the CQI inputted in parallel from high-order bit transmission control section 602, or the low-order bits of the CQI inputted in parallel from low-order bit transmission control section 603. Since other parts of the configuration and operation of P/S conversion section 106 are the same as that according to Embodiment 1, the explanation thereof will be omitted.

### <CQI Transmitting Method 1: Transmitting all Bits of CQI at Communication Start Time>

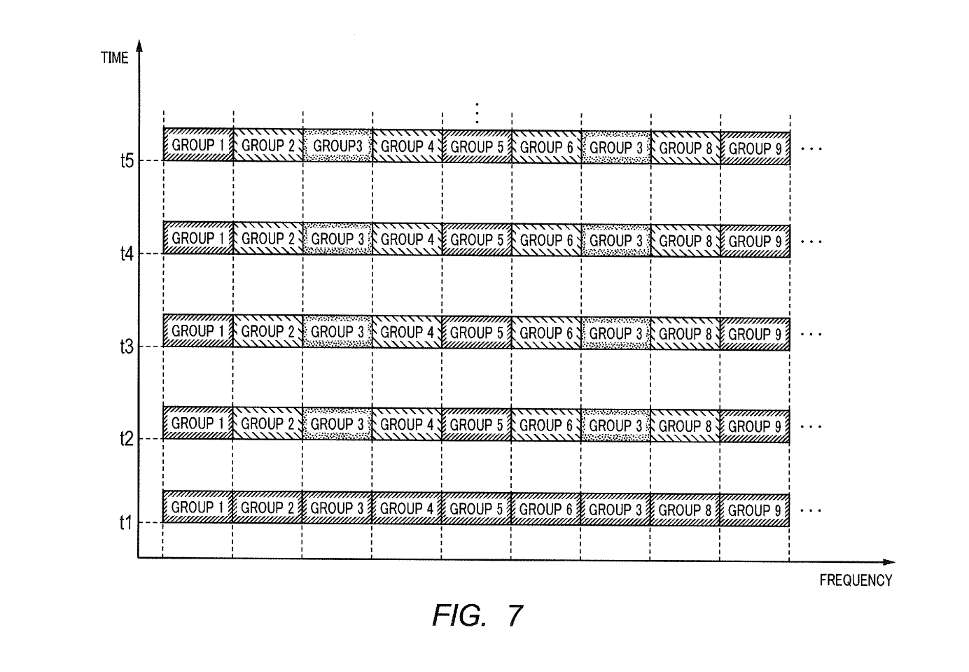

FIG. 7 illustrates CQI transmitting method 1 according to Embodiment 3 of the present invention.

High-order bit transmission control section 602 determines at least communication start time t1 as a transmission time for the high-order bits of the CQI, as illustrated in FIG. 7.

Low-order bit transmission control section 603 determines at least communication start time t1 as a transmission time for the low-order bits of the CQI, as illustrated in FIG. 7.

That is, transmission apparatus 600 transmits all the bits of the high-order bits and low-order bits of the CQI at communication start time t1 represented by the information inputted from timing generation section 601.

<CQI Transmitting Method 2: Transmitting all Bits of CQI at Specific Time after Start of Communication>

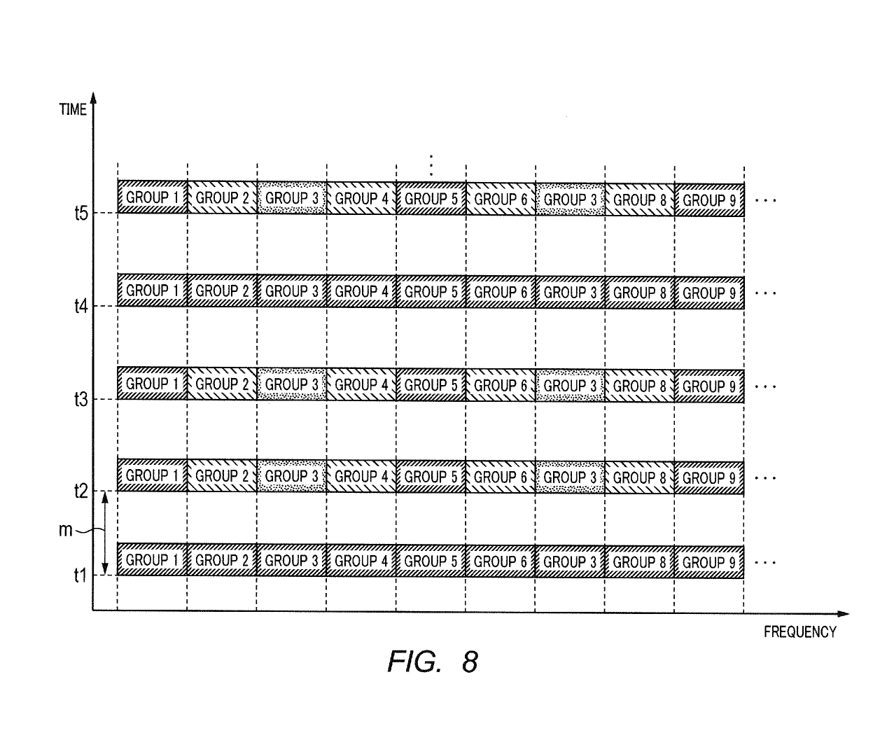

FIG. 8 illustrates CQI transmitting method 2 according to Embodiment 3 of the present invention.

High-order bit transmission control section 602 determines the times at time intervals of 4m (where m>0) from communication start time t1, as a transmission time for the high-order bits of the CQI. That is, high-order bit transmission control section 602 determines times t1, t4, . . . , as a transmission time for the high-order bit of the CQI, as illustrated in FIG. 8.

Low-order bit transmission control section 603 determines the times at time intervals of m from communication start time t1, as a transmission time for the low-order bits of the CQI. That is, low-order bit transmission control section 603 determines times t1, t2, t3, t4, t5, . . . , as a transmission time for the low-order bit of the CQI, as illustrated in FIG. 8.

That is, transmission apparatus 600 transmits all the bits of the CQI at communication start times t1, t4 represented by the information inputted from timing generation section 601.

In the present embodiment, all the bits of the CQI are preferably transmitted at a communication start time. This is because reception apparatus 200 may select a different transmission rate from a transmission rate requested by transmission apparatus 600 if a channel error occurs in a CQI transmitted from transmission apparatus 600. Consequently, in order to avoid a selection error in a transmission rate due to a channel error in the CQI, reception apparatus 200 may average the received CQIs multiple times. However, reception apparatus 200 has only a few reception samples of the CQIs at a communication start time. In particular, since the transmission interval for the high-order bits of the CQI is longer than the transmission interval for the low-order bits, and the number of samples of the high-order bits of the CQIs is small. Therefore, the above-described effect by averaging the CQIs is not acquired, but the probability of reception apparatus 200 making an error in selecting a transmission rate increases.

However, reception apparatus 200 can receive all the bits of CQI by transmitting all the bits of CQI at a communication start time, and this can prevent an increase in the probability of mistaking the selection of a transmission rate.

### <Advantageous Effects of Present Embodiment>

In addition to the advantageous effect of Embodiment 1, the present embodiment transmits all the bits of the CQI at a specific time, such as a communication start time, and can therefore reduce the information amount of the transmission rate request signal without decreasing the throughput and can achieve low power consumption.

Moreover, the present embodiment can reduce the information amount of a CQI without changing the format of the CQI, only by controlling transmission frequency intervals (transmission repetitions) for the high-order bits and low-order bits of the CQI.

Moreover, according to the present embodiment, the probability of making an error in selecting a transmission rate at a communication start time can be reduced when all the bits of the CQI are transmitted at a communication start time.

### <Variation of Present Embodiment>

Although according to the present embodiment, all the bits of CQI are transmitted at a communication start time, the present invention is not limited to this configuration, and only the high-order bits of the CQI may be transmitted at a communication start time.

### Embodiment 4

### <Configuration of Transmission Apparatus>

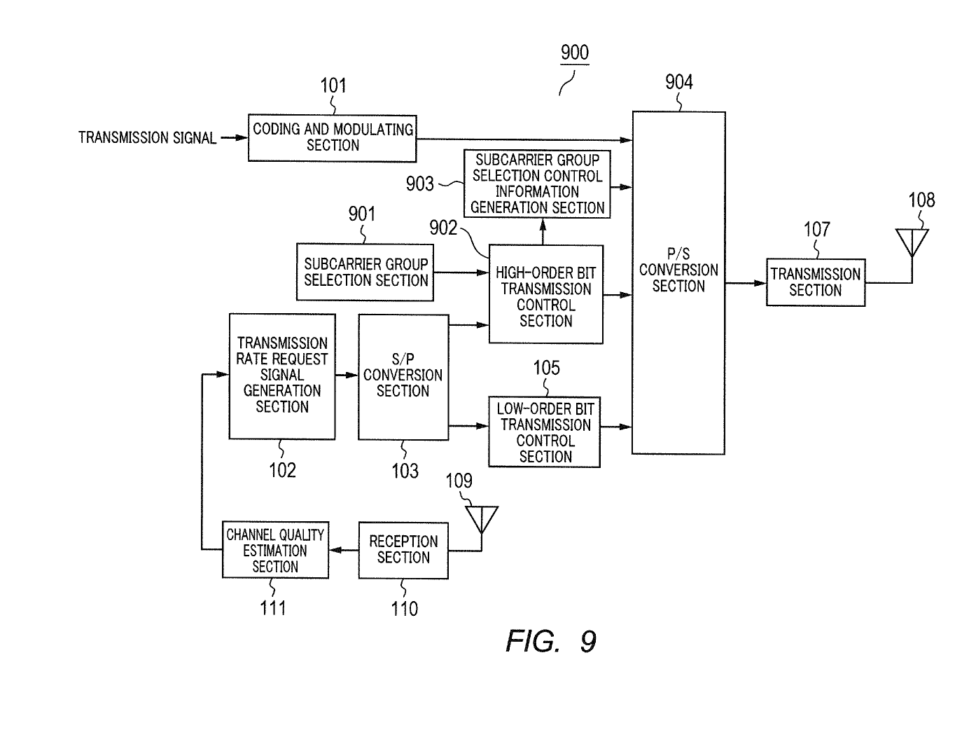

FIG. 9 is a block diagram illustrating a configuration of transmission apparatus 900 according to Embodiment 4 of the present invention. Transmission apparatus 900 is applicable to a communication terminal apparatus, such as a mobile telephone.

Transmission apparatus 900 illustrated in FIG. 9 is different from transmission apparatus 100 according to Embodiment 1 illustrated in FIG. 1 in the following points. That is, transmission apparatus 900 includes a configuration in which subcarrier group selection section 901 and subcarrier group selection control information generation section 903 are added to transmission apparatus 100. Moreover, in comparison with transmission apparatus 100, transmission apparatus 900 has high-order bit transmission control section 902 instead of high-order bit transmission control section 104, and has P/S conversion section 904 instead of P/S conversion section 106. In FIG. 9, the same elements as those in FIG. 1 are designated with the same reference numerals, and the explanations thereof will be omitted. Moreover, since a reception apparatus according to the present embodiment has the same configuration as that in FIG. 2, the explanation thereof will be omitted.

Subcarrier group selection section 901 selects a subcarrier group for transmitting all the bits of the CQI, and outputs control information for reporting the selected subcarrier group, to high-order bit transmission control section 902. For example, subcarrier group selection section 901 selects a subcarrier group in sequence in predetermined order at each transmission time for the CQI.

S/P conversion section 103 outputs the high-order bits of the CQI to high-order bit transmission control section 902, and outputs the low-order bits of the CQI to low-order bit transmission control section 105. Since other parts of the configuration and operation of S/P conversion section 103 are the same as that according to Embodiment 1, the explanation thereof will be omitted.

High-order bit transmission control section 902 sets a subcarrier group for transmitting all the bits of CQI, based on the control information inputted from subcarrier group selection section 901. High-order bit transmission control section 902 outputs the high-order bits of the CQI to P/S conversion section 904 so as to transmit all the bits of CQI in the set subcarrier group. High-order bit transmission control section 902 outputs the subcarrier group set as a subcarrier group for transmitting all the bits of CQI to subcarrier group selection control information generation section 903. Since other parts of the configuration and operation of high-order bit transmission control section 902 are the same as that of high-order bit transmission control section 104 according to Embodiment 1, the explanation thereof will be omitted.

Subcarrier group selection control information generation section 903 generates control information representing the combination of subcarrier groups for transmitting all the bits of CQI, based on the subcarrier groups for transmitting all the bits of the CQI inputted from high-order bit transmission control section 902. Subcarrier group selection control information generation section 903 outputs the generated control information to P/S conversion section 904.

P/S conversion section 904 converts, into series, the high-order bit of the CQI inputted in parallel from high-order bit transmission control section 902, or the low-order bit of the CQI inputted in parallel from low-order bit transmission control section 105 (parallel/serial (P/S) conversion). P/S conversion section 904 generates one sequence signal. This signal includes the transmission signal inputted from coding and modulating section 101, the control information inputted from subcarrier group selection control information generation section 903, and the high-order bits of the CQI inputted from high-order bit transmission control section 902 or the low-order bits of the CQI inputted from low-order bit transmission control section 105. P/S conversion section 904 outputs the generated signal to transmission section 107.

Transmission section 107 performs a transmission process on the signal inputted from P/S conversion section 904, and outputs the signal after the transmission process to antenna 108.

### <CQI Transmitting Method>

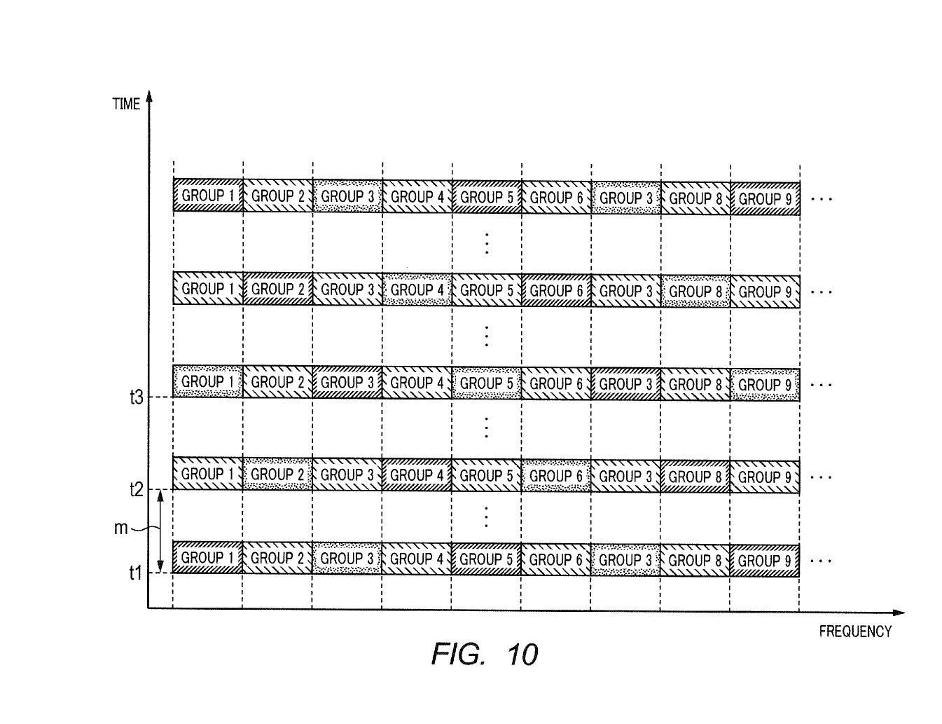

FIG. 10 illustrates a CQI transmitting method according to Embodiment 4 of the present invention.

For example, as illustrated in FIG. 10, subcarrier groups for transmitting all the bits of the CQI are shifted one by one at predetermined time intervals of m. More specifically, subcarrier group selection section 901 selects groups 1, 3, and 5 at time t1 as subcarrier groups for transmitting all the bits of the CQI. At time t2, subcarrier group selection section 901 shifts the subcarrier groups selected at time t1 by one group, and selects groups 2, 4, and 6 as subcarrier groups for transmitting all the bits of the CQI. At time t3, subcarrier group selection section 901 shifts the subcarrier groups selected at time t2 by one group, and selects groups 1, 3, and 5 as subcarrier groups for transmitting all the bits of the CQI. Subcarrier group selection section 901 subsequently selects subcarrier groups in a similar manner.

The CQI of a subcarrier group with a large fall of the reception level due to multipath may have a large difference from the CQIs of the previous and next subcarrier groups. If a subcarrier group with a large fall of the reception level is a subcarrier group for transmitting only low-order bits, an error in the CQI may increase and causes a decrease in the throughput. However, the present embodiment selects a subcarrier group for transmitting all the bits of the CQI by shifting the subcarrier groups one by one, and can therefore prevent a decrease in the throughput.

### <Advantageous Effects of Present Embodiment>

In addition to the advantageous effect of Embodiment 1, the present embodiment selects a subcarrier group for transmitting all the bits of the CQI by shifting the subcarrier groups one by one, and can therefore prevent a decrease in the throughput.

### Embodiment 5

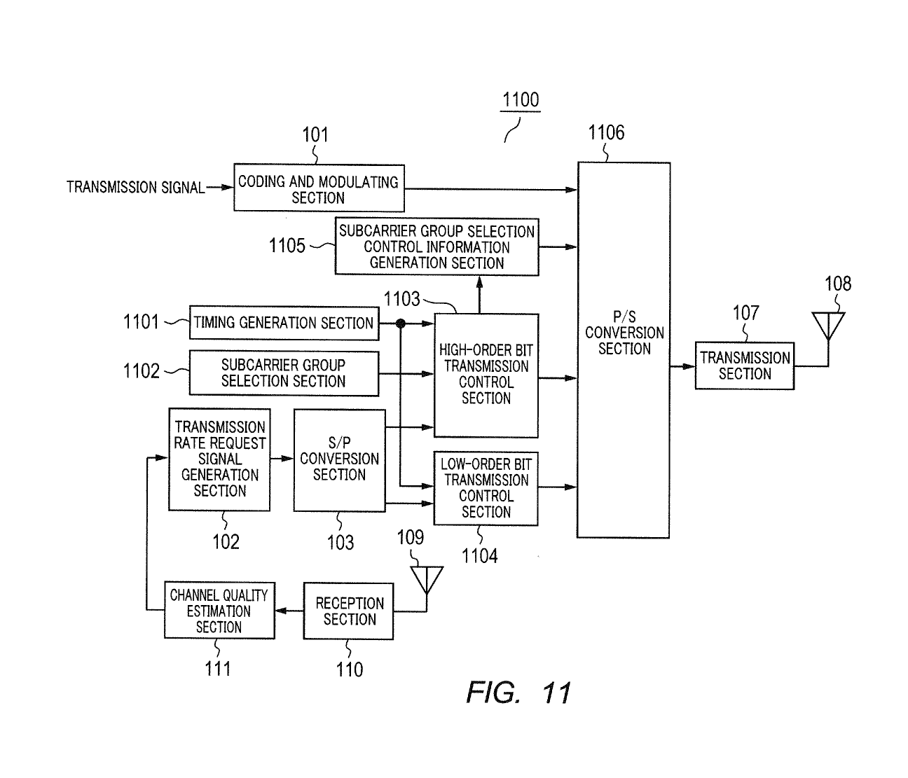

FIG. 11 is a block diagram illustrating a configuration of transmission apparatus 1100 according to Embodiment 5 of the present invention. Transmission apparatus 1100 is applicable to a communication terminal apparatus, such as a mobile telephone.

Transmission apparatus 1100 illustrated in FIG. 11 is different from transmission apparatus 100 according to Embodiment 1 illustrated in FIG. 1, in the following points. That is, transmission apparatus 1100 includes a configuration in which timing generation section 1101, subcarrier group selection section 1102, and subcarrier group selection control information generation section 1105 are added to transmission apparatus 100. Moreover, in comparison with transmission apparatus 100, transmission apparatus 1100 has high-order bit transmission control section 1103 instead of high-order bit transmission control section 104, has low-order bit transmission control section 1104 instead of low-order bit transmission control section 105, and has P/S conversion section 1106 instead of P/S conversion section 106. In FIG. 11, the same elements as those in FIG. 1 are designated with the same reference numerals, and the explanations thereof will be omitted. Moreover, since a reception apparatus according to the present embodiment has the same configuration as that in FIG. 2, the explanation thereof will be omitted.

Timing generation section 1101 generates timing information representing the timing of transmitting the high-order bits and low-order bits of the CQI. Timing generation section 1101 outputs the generated timing information to high-order bit transmission control section 1103 and low-order bit transmission control section 1104. Here, the timing represented by the timing information is the timing of transmitting all the bits of the CQI. The timing of transmitting all the bits of the CQI is a specific time of transmitting, for example, information (second information) required to have higher communication quality than other information (first information). The information required to have higher communication quality than other information is, for example, control information, retransmission information, Ack/Nack information used for a retransmission control, MBMS (Multimedia Broadcast/Multicast Service) information, or a systematic bit when a turbo code is used as an error correcting code.

Subcarrier group selection section 1102 selects a subcarrier group for transmitting all the bits of the CQI, and outputs control information for reporting the selected subcarrier group, to high-order bit transmission control section 1103. For example, subcarrier group selection section 1102 selects a subcarrier group in sequence in predetermined order at each transmission time for the CQI.

S/P conversion section 103 outputs the high-order bits of the CQI to high-order bit transmission control section 1103, and outputs the low-order bits of the CQI to low-order bit transmission control section 1104. Since other parts of the configuration and operation of S/P conversion section 103 are the same as that according to Embodiment 1, the explanation thereof will be omitted.

High-order bit transmission control section 1103 determines a transmission time for the high-order bits of the CQI, based on the time represented by the timing information inputted from timing generation section 1101. High-order bit transmission control section 1103 sets a subcarrier group for transmitting all the bits of the CQI, based on the control information inputted from subcarrier group selection section 1102. High-order bit transmission control section 1103 outputs the high-order bits of the CQI to P/S conversion section 1106 to transmit all the bits in the set subcarrier group at the determined transmission time. High-order bit transmission control section 1103 outputs the subcarrier group set as a subcarrier group for transmitting all the bits of the CQI to subcarrier group selection control information generation section 1105. Since other parts of the configuration and operation of high-order bit transmission control section 1103 are the same as those of high-order bit transmission control section 104 according to Embodiment 1, the explanation thereof will be omitted.

Low-order bit transmission control section 1104 determines a transmission time for the low-order bits of the CQI based on the time represented by the timing information inputted from timing generation section 1101. Low-order bit transmission control section 1104 outputs the low-order bits of the CQI to P/S conversion section 1106 at the determined transmission time. Since other parts of the configuration and operation of low-order bit transmission control section 1104 are the same as that of low-order bit transmission control section 105 according to Embodiment 1, the explanation thereof will be omitted.

Subcarrier group selection control information generation section 1105 generates control information representing the combination of subcarrier groups for transmitting all the bits of the CQI, based on the subcarrier groups for transmitting all the bits of the CQI inputted from high-order bit transmission control section 1103. Subcarrier group selection control information generation section 1105 outputs the generated control information to P/S conversion section 1106.

P/S conversion section 1106 converts, into series, the high-order bits of the CQI inputted in parallel from high-order bit transmission control section 1103, or the low-order bits of the CQI inputted in parallel from low-order bit transmission control section 1104. P/S conversion section 1106 generates one sequence signal. This signal includes the transmission signal inputted from coding and modulating section 101, the control information inputted from subcarrier group selection control information generation section 1105, and the high-order bits of the CQI inputted from high-order bit transmission control section 1103 or the low-order bits of the CQI inputted from low-order bit transmission control section 1104. P/S conversion section 1106 outputs the generated signal to transmission section 107.

Transmission section 107 performs a transmission process on the signal inputted from P/S conversion section 1106, and outputs the signal after the transmission process, to antenna 108.

### <CQI Transmitting Method>

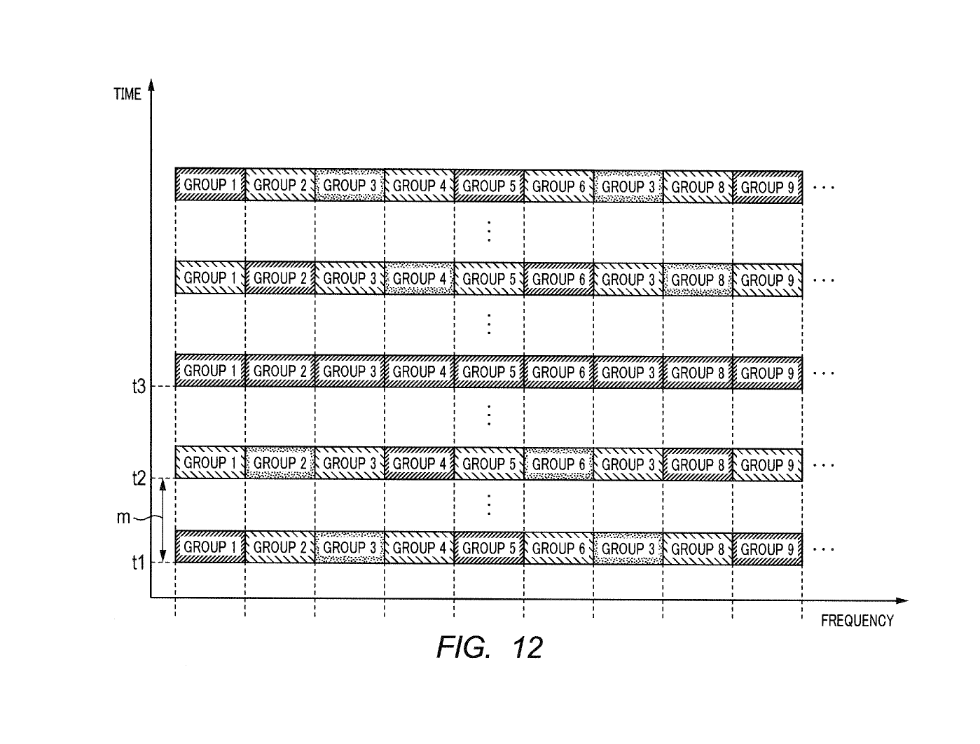

FIG. 12 illustrates a CQI transmitting method according to Embodiment 5 of the present invention.

As illustrated in FIG. 12, all the bits of the CQI are transmitted at specific time t3. Specific time t3 is the time of transmitting, for example, information required to have higher communication quality than other information. The information required to have higher communication quality than other information is, for example, control information, retransmission information, MBMS information, or a systematic bit when a turbo code is used as an error correcting code. Since other parts of the CQI transmitting method are the same as that according to Embodiment 4, the explanation thereof will be omitted.

### <Advantageous Effects of Present Embodiment>

In addition to the advantageous effect of Embodiment 1, the present embodiment transmits all the bits of the CQI at a specific time, and can thereby improve the communication quality of information required to have higher communication quality than other information, almost without an increase in the transmission amount of the CQI.

### <Variation of Present Embodiment>

In the present embodiment, the subcarrier groups for transmitting all the bits of the CQI are shifted one by one at each predetermined time. However, the present invention is not limited to this configuration. For example, in the present invention, the subcarrier groups for transmitting all the bits of the CQI may be shifted by two subcarrier groups at each predetermined time. Alternatively, the subcarrier groups for transmitting all the bits of the CQI may be shifted by any number of subcarrier groups.

### Embodiment 6

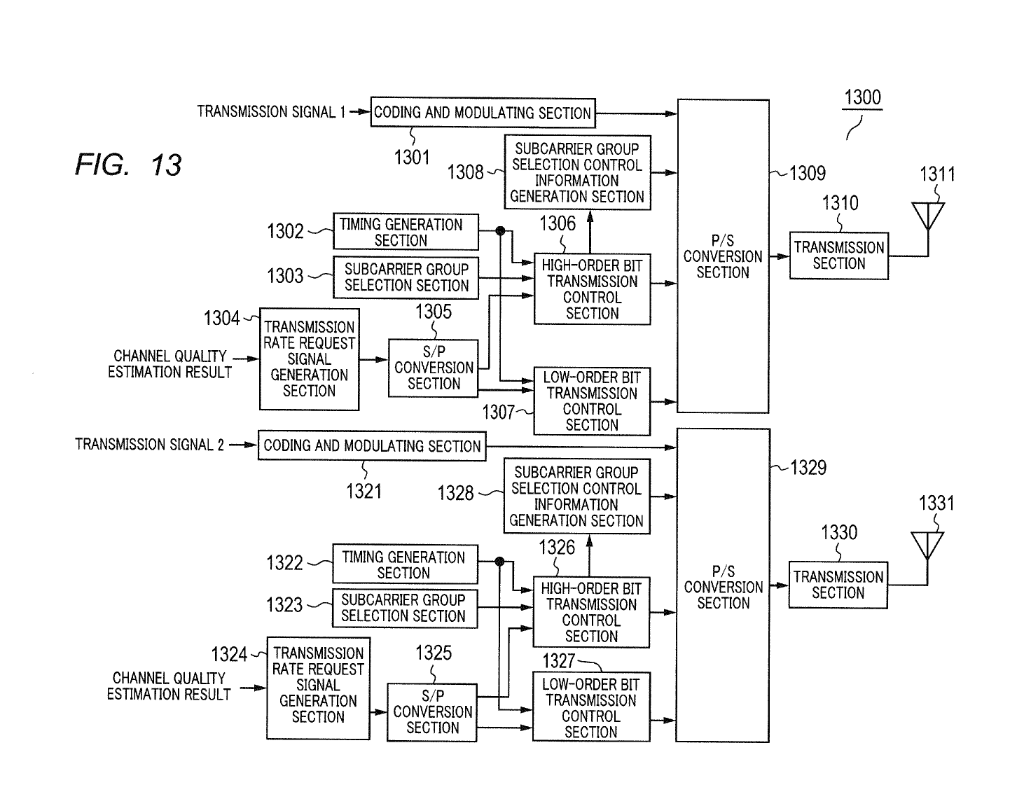

FIG. 13 is a block diagram illustrating a configuration of transmission apparatus 1300 according to Embodiment 6 of the present invention. Transmission apparatus 1300 is applicable to a communication terminal apparatus, such as a mobile telephone.

Coding and modulating section 1301 performs an encode process and a modulation process on inputted transmission signal 1. Coding and modulating section 1301 outputs transmission signal 1 after the modulation process to P/S conversion section 1309.

Timing generation section 1302 generates timing information representing the timing of transmitting the high-order bit of the CQI. Timing generation section 1302 outputs the generated timing information to high-order bit transmission control section 1306 and low-order bit transmission control section 1307. Here, the timing represented by the timing information is the timing of transmitting all the bits of the CQI. The timing of transmitting all the bits of the CQI is, for example, a communication start time or a specific time after the start of communication. The specific time is, for example, a time when a reception level falls significantly due to multipath, i.e., when the value of a CQI varies rapidly.

Subcarrier group selection section 1303 selects a subcarrier group for transmitting all the bits of the CQI, and outputs control information for reporting the selected subcarrier group, to high-order bit transmission control section 1306. For example, subcarrier group selection section 1303 selects a subcarrier group in sequence in predetermined order at each transmission time for the CQI.

Transmission rate request signal generation section 1304 generates a CQI as a control signal for requesting a transmission rate in accordance with an estimation result of a channel quality representing the channel condition of transmission apparatus 1300, the estimation result being inputted from a channel quality estimation section not illustrated. Transmission rate request signal generation section 1304 outputs the generated CQI to S/P conversion section 1305.

S/P conversion section 1305 converts, into a parallel data form, the CQI inputted in a serial data form from transmission rate request signal generation section 1304. S/P conversion section 1305 separates, into high-order bits and low-order bits, the CQI converted into a parallel data form. S/P conversion section 1305 outputs the high-order bits of the CQI to high-order bit transmission control section 1306, and outputs the low-order bits of the CQI to low-order bit transmission control section 1307.

High-order bit transmission control section 1306 functions as a transmission control section for determining a transmission time for a CQI. High-order bit transmission control section 1306 sets a transmission subcarrier group for the high-order bits of the CQI inputted from S/P conversion section 1305. In this case, high-order bit transmission control section 1306 sets the transmission frequency interval for the high-order bit of the CQI so as to be longer than the transmission frequency interval for the low-order bit of the CQI set in low-order bit transmission control section 1307 described below. High-order bit transmission control section 1306 determines a transmission time for the high-order bits of the CQI, based on the time represented by the timing information inputted from timing generation section 1302. Furthermore, high-order bit transmission control section 1306 sets a subcarrier group for transmitting all the bits of the CQI, based on the control information inputted from subcarrier group selection section 1303. High-order bit transmission control section 1306 sets a subcarrier group and then outputs the high-order bits of the CQI to P/S conversion section 1309 at the determined transmission time. High-order bit transmission control section 1306 outputs the subcarrier group set as a subcarrier group for transmitting all the bits of the CQI, to subcarrier group selection control information generation section 1308. High-order bit transmission control section 1306 performs the above-described control independently from high-order bit transmission control section 1326.

Low-order bit transmission control section 1307 sets a transmission subcarrier group for the low-order bits of the CQI inputted from S/P conversion section 1305. In this case, low-order bit transmission control section 1307 sets the subcarrier group for transmitting the low-order bits in a way that makes the transmission frequency interval for the low-order bits of the CQI shorter than the transmission frequency interval for the high-order bits of the CQI that is set in high-order bit transmission control section 1306. Low-order bit transmission control section 1307 determines a transmission time for the low-order bits of the CQI, based on the time represented by the timing information inputted from timing generation section 1302. Low-order bit transmission control section 1307 sets a subcarrier group and then outputs the low-order bits of the CQI to P/S conversion section 1309 at the determined transmission time.

Subcarrier group selection control information generation section 1308 generates control information representing the combination of subcarrier groups for transmitting all the bits of the CQI, based on the subcarrier groups for transmitting all the bits of the CQI inputted from high-order bit transmission control section 1306. Subcarrier group selection control information generation section 1308 outputs the generated control information to P/S conversion section 1309.

P/S conversion section 1309 converts, into series, the high-order bits of the CQI inputted in parallel from high-order bit transmission control section 1306, or the low-order bits of the CQI inputted in parallel from low-order bit transmission control section 1307. P/S conversion section 1309 generates one sequence signal. This signal includes the transmission signal inputted from coding and modulating section 1301, the control information inputted from subcarrier group selection control information generation section 1308, and the high-order bits of the CQI inputted from high-order bit transmission control section 1306 or the low-order bits of the CQI inputted from low-order bit transmission control section 1307. P/S conversion section 1309 outputs the generated signal to transmission section 1310.

Transmission section 1310 performs a transmission process on the signal inputted from P/S conversion section 1309, and outputs the signal after the transmission process, to antenna 1311.

Antenna 1311 transmits the signal inputted from transmission section 1310. Accordingly, the high-order bits and low-order bits of the CQI are transmitted based on the respective transmission frequency intervals that are set in high-order bit transmission control section 1306 and low-order bit transmission control section 1307.

Coding and modulating section 1321 performs an encode process and a modulation process on inputted transmission signal 2. Coding and modulating section 1321 outputs transmission signal 2 after the modulation process to P/S conversion section 1329.

Timing generation section 1322 generates timing information representing the timing of transmitting the high-order bits of the CQI. Timing generation section 1322 outputs the generated timing information to high-order bit transmission control section 1326 and low-order bit transmission control section 1327. Note that, the timing represented by the timing information is the timing of transmitting all the bits of the CQI. The timing of transmitting all the bits of the CQI is, for example, a communication start time or a specific time after the start of communication. The specific time is, for example, a time when a channel variation speed is high, i.e., a time when the value of a CQI varies rapidly.

Subcarrier group selection section 1323 selects a subcarrier group for transmitting all the bits of the CQI, and outputs control information for reporting the selected subcarrier group, to high-order bit transmission control section 1326. For example, subcarrier group selection section 1323 selects a subcarrier group in sequence in predetermined order at each transmission time for the CQI.

Transmission rate request signal generation section 1324 generates a CQI as a control signal for requesting a transmission rate, in accordance with an estimation result of a channel quality representing the channel condition of transmission apparatus 1300, the estimation result being inputted from a channel quality estimation section not illustrated. Transmission rate request signal generation section 1324 outputs the generated CQI to S/P conversion section 1325.

S/P conversion section 1325 converts, into a parallel data form, the CQI inputted in a serial data form from transmission rate request signal generation section 1324. S/P conversion section 1325 separates, into high-order bits and low-order bits, the CQI converted into a parallel data form. S/P conversion section 1325 outputs the high-order bits of the CQI to high-order bit transmission control section 1326, and outputs the low-order bits of the CQI to low-order bit transmission control section 1327.

High-order bit transmission control section 1326 functions as a transmission control section for determining a transmission time for a CQI. High-order bit transmission control section 1326 sets a transmission subcarrier group for the high-order bits of the CQI inputted from S/P conversion section 1325. In this case, high-order bit transmission control section 1326 sets a subcarrier group for transmitting the high-order bits in a way that makes a transmission frequency interval for the high-order bits of the CQI longer than a transmission frequency interval, which is set in low-order bit transmission control section 1327 described below, for the low-order bits of the CQI. High-order bit transmission control section 1326 determines a transmission time for the high-order bits of the CQI, based on the time represented by the timing information inputted from timing generation section 1322. Furthermore, high-order bit transmission control section 1326 sets a subcarrier group for transmitting all the bits of the CQI, based on the control information inputted from subcarrier group selection section 1323. High-order bit transmission control section 1326 sets a subcarrier group and then outputs the high-order bits of the CQI to P/S conversion section 1329 at the determined transmission time. High-order bit transmission control section 1326 outputs the subcarrier group determined as a subcarrier group for transmitting all the bits of the CQI, to subcarrier group selection control information generation section 1328. High-order bit transmission control section 1326 performs the above-described control independently from high-order bit transmission control section 1306.

Low-order bit transmission control section 1327 sets a transmission subcarrier group for the low-order bits of the CQI inputted from S/P conversion section 1325. In this case, low-order bit transmission control section 1327 sets the subcarrier group for transmitting the low-order bits in a way that makes the transmission frequency interval for the low-order bits of the CQI shorter than the transmission frequency interval for the high-order bits of the CQI that is set in high-order bit transmission control section 1326. Low-order bit transmission control section 1327 determines a transmission time for the low-order bits of the CQI based on the time represented by the timing information inputted from timing generation section 1322. Low-order bit transmission control section 1327 sets a subcarrier group and then outputs the low-order bits of the CQI to P/S conversion section 1329 at the determined transmission time.

Subcarrier group selection control information generation section 1328 generates control information representing the combination of subcarrier groups for transmitting all the bits of the CQI, based on the subcarrier groups for transmitting all the bits of the CQI inputted from high-order bit transmission control section 1326. Subcarrier group selection control information generation section 1328 outputs the generated control information to P/S conversion section 1329.

P/S conversion section 1329 converts, into series, the high-order bits of the CQI inputted in parallel from high-order bit transmission control section 1326, or the low-order bits of the CQI inputted in parallel from low-order bit transmission control section 1327. P/S conversion section 1329 generates one sequence signal. This signal includes the transmission signal inputted from coding and modulating section 1321, the control information inputted from subcarrier group selection control information generation section 1328, and the high-order bits of the CQI inputted from high-order bit transmission control section 1326 or the low-order bits of the CQI inputted from low-order bit transmission control section 1327. P/S conversion section 1329 outputs the generated signal to transmission section 1330.

Transmission section 1330 performs a transmission process on the signal inputted from P/S conversion section 1329, and outputs the signal after the transmission process to antenna 1331.

Antenna 1331 transmits the signal inputted from transmission section 1330. Accordingly, the high-order bits and low-order bits of the CQI are transmitted based on the respective transmission frequency intervals that are set in high-order bit transmission control section 1326 and low-order bit transmission control section 1327.

### <CQI Transmitting Method>

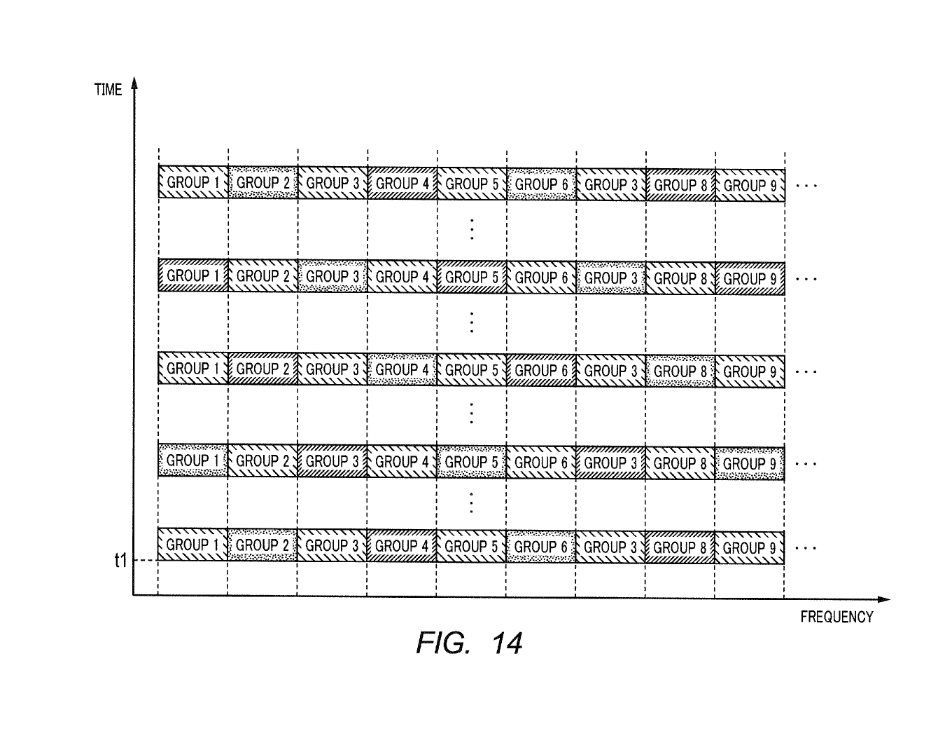

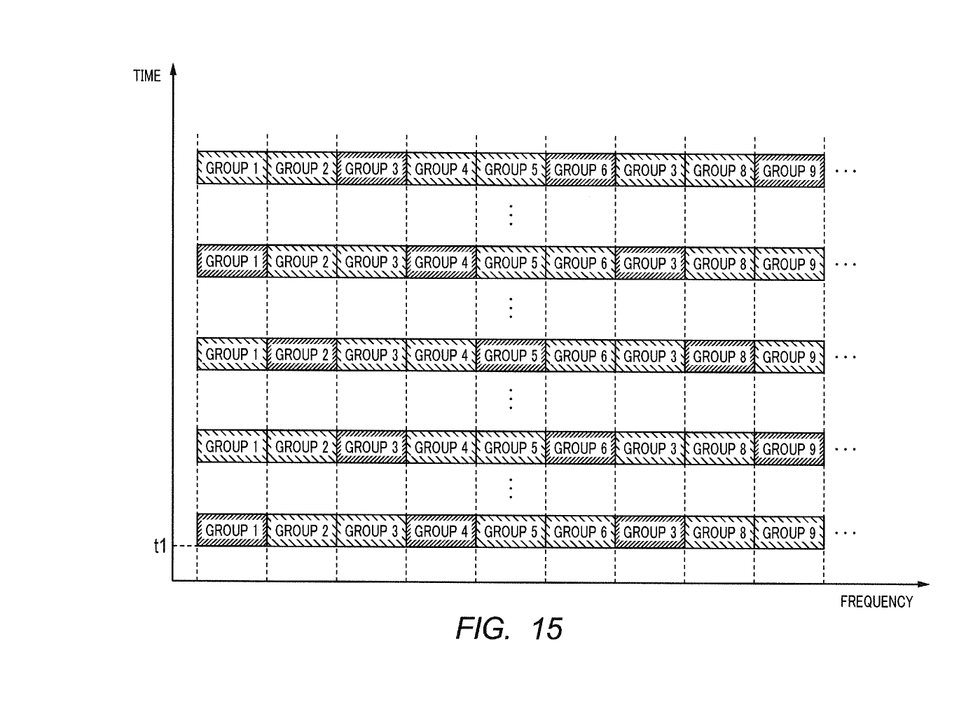

FIG. 14 illustrates the CQI transmitting method for a CQI transmitted from one antenna 1311 of two antennas. FIG. 15 illustrates the CQI transmitting method for a CQI transmitted from antenna 1331 that is the other one of the two antennas.

In the present embodiment, when using a MIMO (Multi-Input Multi-Output) scheme as a communication scheme, transmission apparatus 1300 sets a subcarrier group interval for transmitting all the bits of the CQI independently for each antenna.

High-order bit transmission control section 1306 and high-order bit transmission control section 1326 control frequency intervals for transmitting all the bits of the CQI, independently from each other. For example, when the number of antennas is two, high-order bit transmission control section 1306 sets a subcarrier group interval for transmitting all the bits of the CQI as illustrated in FIG. 14, for the CQI transmitted from first antenna 1311. Moreover, high-order bit transmission control section 1326 sets a subcarrier group interval for transmitting all the bits of the CQI as illustrated in FIG. 15, for the CQI transmitted from second antenna 1331.

For example, for the CQI transmitted at time t1, transmission apparatus 1300 transmits all the bits of the CQI in groups 2, 4, 6, 8, . . . from antenna 1311, and transmits all the bits of the CQI in groups 1, 4, 7, . . . from antenna 1331. In this way, transmission apparatus 1300 makes a subcarrier group interval for transmitting all the bits of the CQI shorter for the CQI transmitted from antenna 1311 than for the CQI transmitted from antenna 1331.

### <Advantageous Effects of Present Embodiment>

According to the present embodiment, in addition to the advantageous effect of Embodiment 1, the following advantageous effects can be acquired. That is, the present embodiment sets a subcarrier group interval for transmitting all the bits of the CQI independently for each antenna in the MIMO scheme. Thereby, the present embodiment can improve the communication quality of information required to have higher communication quality than other information, almost without increasing the transmission amount of the CQI.

### <Variations of Present Embodiment>

Although the present embodiment fixes subcarrier group intervals for transmitting all the bits of the CQI in all antennas, the present invention is not limited to this configuration and may set subcarrier group intervals for transmitting all the bits of the CQI to be variable in some or all of all the antennas.

Although the present embodiment transmits all the bits of the CQI in all antennas, the present invention is not limited to this configuration and may transmit all the bits of the CQI in only one specific antenna. This scheme is effective, for example, when one specific antenna transmits information required to have higher communication quality than other information.

Although the present embodiment provides two antennas, the present invention is not limited to this configuration and may provide any number more than two of antennas.

The present embodiment may set a subcarrier group for transmitting all the bits of the CQI independently for each antenna.

### Embodiment 7

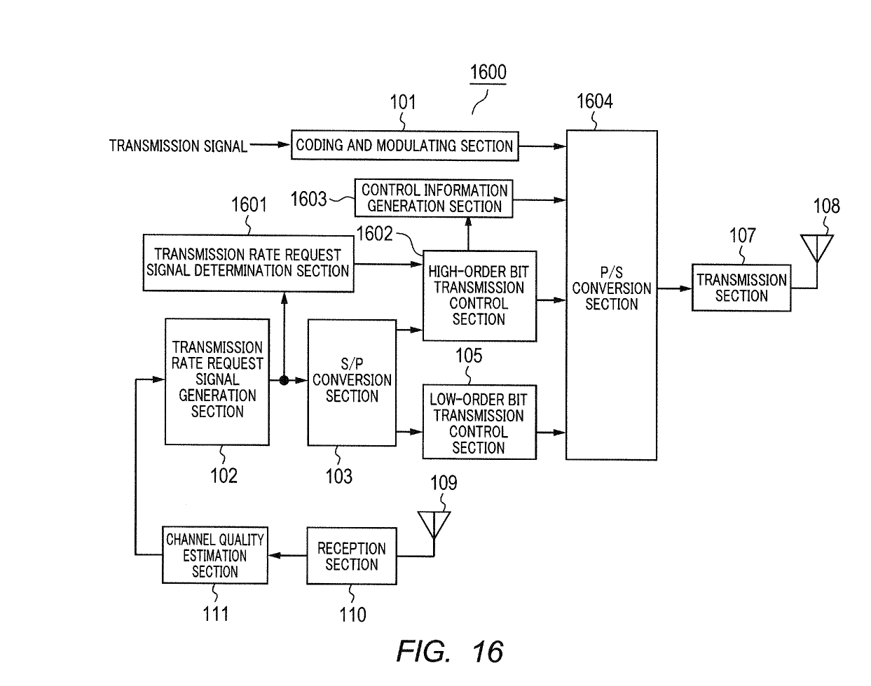

FIG. 16 is a block diagram illustrating a configuration of transmission apparatus 1600 according to Embodiment 7 of the present invention. Transmission apparatus 1600 is applicable to a communication terminal apparatus, such as a mobile telephone.

Transmission apparatus 1600 illustrated in FIG. 16 is different from transmission apparatus 100 according to Embodiment 1 illustrated in FIG. 1, in the following points. That is, transmission apparatus 1600 includes a configuration in which transmission rate request signal determination section 1601 and control information generation section 1603 are added to transmission apparatus 100. Moreover, in comparison with transmission apparatus 100, transmission apparatus 1600 has high-order bit transmission control section 1602 instead of high-order bit transmission control section 104, and has P/S conversion section 1604 instead of P/S conversion section 106. In FIG. 16, the same elements as those in FIG. 1 are designated with the same reference numerals, and the explanations thereof will be omitted. Moreover, since a reception apparatus according to the present embodiment has the same configuration as that in FIG. 2, the explanation thereof will be omitted.

Transmission rate request signal generation section 102 generates a CQI as a control signal for requesting a transmission rate, in accordance with an estimation result of a channel quality representing the channel condition of transmission apparatus 1600, the estimation result being inputted from channel quality estimation section 111. Transmission rate request signal generation section 102 outputs the generated CQI to S/P conversion section 103 and transmission rate request signal determination section 1601.

Transmission rate request signal determination section 1601 refers to the CQI inputted in sequence from transmission rate request signal generation section 102. From the result of the reference, transmission rate request signal determination section 1601 determines whether the value of the highest-order bit of the CQI generated at the current time varies in comparison with the highest-order bit of the CQI generated at the previous time. When determining that the value of the highest-order bit of the CQI varies, transmission rate request signal determination section 1601 instructs high-order bit transmission control section 1602 to transmit the high-order bits of the CQI.

When being instructed to transmit the high-order bits of the CQI from transmission rate request signal determination section 1601, high-order bit transmission control section 1602 determines the instructed time as a transmission time for the high-order bits of the CQI. High-order bit transmission control section 1602 outputs the instructed time of transmission for the high-order bits of the CQI, to control information generation section 1603. High-order bit transmission control section 1602 sets a subcarrier group and then outputs the high-order bits of the CQI to P/S conversion section 1604 at the instructed time. Since other parts of the configuration and operation of high-order bit transmission control section 1602 are the same as that of high-order bit transmission control section 104 according to Embodiment 1, the explanation thereof will be omitted.

Control information generation section 1603 generates control information reporting the instructed time inputted from high-order bit transmission control section 1602. In this case, the control information is set to “1” when the high-order bits of the CQI is transmitted, and to “0” when the high-order bits of the CQI is not transmitted. Control information generation section 1603 outputs the generated control information to P/S conversion section 1604.

P/S conversion section 1604 converts, into series, the high-order bits of the CQI inputted in parallel from high-order bit transmission control section 1602, or the low-order bits of the CQI inputted in parallel from low-order bit transmission control section 105. P/S conversion section 1604 generates one sequence signal including the transmission signal inputted from coding and modulating section 101, and the high-order bit of the CQI inputted from high-order bit transmission control section 1602 or the low-order bit of the CQI inputted from low-order bit transmission control section 105. In this case, when control information is inputted from control information generation section 1603, P/S conversion section 1604 generates one sequence signal including the control information. P/S conversion section 1604 outputs the generated signal to transmission section 107.

### <CQI Transmitting Method>

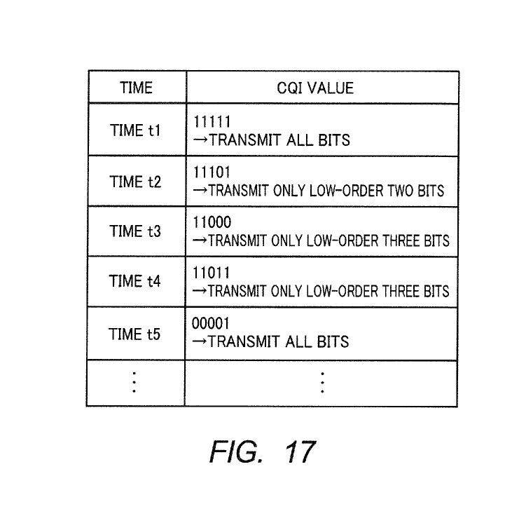

FIG. 17 illustrates a CQI transmitting method according to Embodiment 7 of the present invention.

With reference to FIG. 17, transmission apparatus 1600 transmits all the bits “11111” of the CQI at time t1. On the other hand, transmission apparatus 1600 transmits only the low-order two bits “01” at time t2. Transmission apparatus 1600 transmits only the low-order three bits “000” at time t3. Transmission apparatus 1600 transmits only the low-order three bits “011” at time t4. On the other hand, the highest-order bit of the CQI varies at time t5, to “0” from “1” transmitted at time t1 to t4. Therefore, transmission apparatus 1600 transmits all the bits of the CQI at time t5.

### <CQI Generating Method in Reception Apparatus>

With reference to FIG. 17, reception apparatus 200 receives all the bits of the CQI at time t1 and time t5. On the other hand, reception apparatus 200 receives only the low-order two bits at time t2, but transmission rate request signal generation section 203 can generate all the bits “11101” of the CQI using the received low-order two bits “01” and the high-order three bits “111” received at time t1. Moreover, reception apparatus 200 receives only the low-order three bits at time t3, but transmission rate request signal generation section 203 can generate all the bits “11000” of the CQI using the received low-order three bits “000” and the high-order two bits “11” received at time t1. Reception apparatus 200 receives only the low-order two bits at time t4 illustrated in FIG. 3, but transmission rate request signal generation section 203 can generate all the bits “10011” of the CQI using the received low-order two bits “11” and the high-order three bits “100” received at time t5.

<Reason for Transmitting all Bits of CQI when Highest-Order Bit of CQI>

The highest-order bit in multiple bits representing the CQI can represent the largest value. Moreover, at a time when the highest-order bit of the CQI varies, there is a high possibility that all bits other than the highest-order bit of the CQI varies. For example, if a CQI including five bits is incremented from “01111” by one, the value varies to “10000,” i.e., the highest-order bit of the CQI varies from “0” to “1” while all bits other than the highest-order bit of the CQI vary from “1111” to “0000.” The same is true for the CQI varying from “10000” to “01111.”

Here, since transmission apparatus 1600 sets a longer transmission interval for the high-order bits of a CQI than transmission interval for the low-order bits of a CQI, the highest-order bit of a CQI generated at a time other than a transmission time for the high-order bits of a CQI may vary relative to the highest-order bit of a CQI generated at the previous time. That is, at a time when the highest-order bit of a CQI varies (i.e., when all bits other than the highest-order bit of a CQI may vary), the highest-order bit of the CQI may not be transmitted. In this case, reception apparatus 200 specifies the received CQI as a completely different value from the actual CQI, and selects a different transmission rate from a transmission rate requested reality by transmission apparatus 1600. Consequently, in the present embodiment, transmission apparatus 1600 transmits all the bits of a CQI at a time when the highest-order bit of the CQI varies.

That is, every time the value of the highest-order bit of a CQI varies, transmission apparatus 1600 transmits the high-order bits of the CQI. Thereby, reception apparatus 200 can receive all the bits of a CQI at a time when the highest-order bit of the CQI varies. That is, at a time when the highest-order bit of a CQI varies, reception apparatus 200 can surely select an appropriate transmission rate using the CQI reflecting the latest channel condition.

Note that, in the present embodiment, the information amount for CQI transmission increases by the amount for transmission of control information. However, since transmission apparatus 1600 needs to transmit control information representing the presence or absence of transmission to only the high-order bit of a CQI, an information amount necessary for the control information is only one bit. Therefore, transmission apparatus 1600 can provide an effect of reducing the information amount of a CQI that is greater than the performance deterioration due to an increase in the information amount of the control information. That is, in the present embodiment, the influence on performance deterioration due to an increase in the information amount of the control information is very small.

### <Advantageous Effects of Present Embodiment>

The present embodiment transmits all the bits of a CQI at a time when the highest-order bit of the CQI varies. In addition to the advantageous effects of Embodiment 1, this can prevent erroneously selecting a transmission rate different from a transmission rate requested in reality by the transmission apparatus. This is because the reception apparatus can receive an exact value of a CQI.

### <Variations Common to all Embodiments>

Although Embodiment 1 to Embodiment 7 generate a CQI for each subcarrier group including multiple subcarriers, the present invention is not limited to this configuration and may generate a CQI for each subcarrier.

Although Embodiment 1 to Embodiment 7 use a CQI as a transmission rate request signal, the present invention is not limited to this configuration and may use any signal other than a CQI as a transmission rate request signal.

The disclosure of Japanese Patent Application No. 2011-246482, filed on Nov. 10, 2011, including the specification, drawings and abstract, is incorporated herein by reference in its entirety.

### INDUSTRIAL APPLICABILITY

A transmission apparatus and a transmitting method according to the present invention are suitable for an apparatus and a method that request a transmission rate using a transmission rate request signal.

### REFERENCE SIGNS LIST

100 Transmission apparatus
101 Coding and modulating section
102 Transmission rate request signal generation section
103 S/P Conversion section
104 High-order bit transmission control section
105 Low-order bit transmission control section
106 P/S conversion section
107 Transmission section
108, 109 Antennas
110 Reception section
111 Channel quality estimation section

1. A transmission apparatus comprising:
a generation section that generates a transmission rate request signal for each of frequencies, the transmission rate request signal including a plurality of bits for requesting a transmission rate for each of the frequencies;
a control section that sets a frequency for transmitting a high-order bit and a frequency for transmitting a low-order bit so that a first frequency interval for transmitting the high-order bit in the plurality of bits is longer than a second frequency interval for transmitting the low-order bit other than the high-order bit in the plurality of bits; and
a transmission section that transmits the high-order bit and the low-order bit using the frequencies that are set by the control section.

2. The transmission apparatus according to claim 1, wherein the control section sets the first frequency interval or the second frequency interval to be variable in accordance with a channel condition with a communication counterpart.

3. The transmission apparatus according to claim 1, wherein the control section sets a frequency that is set for transmission of the high-order bit to be variable and thereby sets a frequency for transmitting all the plurality of bits to be variable.

4. The transmission apparatus according to claim 3, wherein the transmission section transmits, to the communication counterpart, information representing the frequency for transmitting all the plurality of bits.

5. The transmission apparatus according to claim 1, wherein the control section sets a frequency for transmitting the high-order bit and a frequency for transmitting the low-order bit so that all the plurality of bits are transmitted in all the frequencies at a specific time.

6. The transmission apparatus according to claim 1, wherein the control section sets a frequency for transmitting the high-order bit and a frequency for transmitting the low-order bit so that all the plurality of bits are transmitted in all the frequencies when communication starts.

7. The transmission apparatus according to claim 1, wherein the control section sets a frequency for transmitting the high-order bit and a frequency for transmitting the low-order bit so that all the plurality of bits are transmitted in all the frequencies when second information required to have higher communication quality than first information is transmitted.

8. The transmission apparatus according to claim 1, further comprising a plurality of antennas, wherein:
the control section sets a frequency for transmitting the high-order bit and a frequency for transmitting the low-order bit independently for each of the plurality of antennas; and
the transmission section transmits the high-order bit and the low-order bit using the frequencies that are set by the control section for each of the plurality of antennas.

9. The transmission apparatus according to claim 1, further comprising a plurality of antennas, wherein:
the control section sets a frequency for transmitting the high-order bit independently for each of the plurality of antennas, and thereby sets a frequency for transmitting all the plurality of bits; and
the transmission section transmits the high-order bit and the low-order bit using the frequencies that are set by the control section for each of the plurality of antennas.

10. The transmission apparatus according to claim 1, wherein the control section sets a frequency for transmitting the high-order bit so that all the plurality of bits are transmitted when a highest-order bit of the transmission rate request signal generated by the generation section this time varies with respect to a highest-order bit of the transmission rate request signal generated by the generation section last time.

11. A communication terminal apparatus comprising the transmission apparatus according to claim 1.

12. A base station apparatus that receives the transmission rate request signal transmitted from the communication terminal apparatus according to claim 11.

13. A transmitting method comprising:
generating a transmission rate request signal for each of frequencies, the transmission rate request signal including a plurality of bits for requesting a transmission rate for each of the frequencies;
setting a frequency for transmitting a high-order bit and a frequency for transmitting a low-order bit so that a first frequency interval for transmitting the high-order bit in the plurality of bits is longer than a second frequency interval for transmitting the low-order bit other than the high-order bit in the plurality of bits; and
transmitting the high-order bit and the low-order bit using the set frequencies.
